(19) United States
(12) Patent Application Publication
(10) Pub. No.: US 2005/0148349 A1
(43) Pub. Date: Jul. 7, 2005

(54) Cell selection on transitioning from dedicated mode in wireless communications devices

(76) Inventors: Padmaja Putcha, Gurnee, IL (US); Steve R. Brandt, Round Lake, IL (US); Donald A. Dorsey, Vernon Hills, IL (US); Rohini Polisetty, Grayslake, IL (US); Sharada Raghuram, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/741,737

(22) Filed: Dec. 19, 2003

(51) Int. Cl. H04Q 7/20

(52) U.S. Cl. 455/458

(57) ABSTRACT

A method in a wireless communications device, including selecting (210) a cell, and after selection, configuring (230) the wireless communications device for a paging channel of a cell camped on previously using system information obtained for the cell camped on previously whether or not the selected cell is the same as the cell camped on previously. In some embodiments, updated system information is obtained for the selected cell if the selected cell is the same as the cell camped on previously, and the paging channel is reconfigured (250) based upon any updated system information obtained for the selected cell. In other embodiments, system information is obtained for the selected cell while the wireless communications device is configured for the paging channel of the cell camped on previously.

### FIELD OF THE DISCLOSURE

The present disclosure relates generally to wireless communications, and more particularly to cell selection and channel configuration of wireless communications devices in cellular communications networks, for example, paging channel configuration upon transitioning of the wireless communications device from dedicated mode to common mode operation, and methods.

### BACKGROUND OF THE DISCLOSURE

In some wireless communications systems, wireless mobile stations are required to perform cell selection upon transitioning from a dedicated channel to a common channel. Exemplary common channels include, among others, paging channels, broadcast and common control channels, etc. The network may move the mobile station to a common channel, e.g., from a Dedicated Channel (DCH) to a Forward Access Channel (FACH), for any number of reasons, including, among others, upon completion of a circuit switched call by the mobile station on a dedicated channel, changes in network traffic and/or other network conditions, availability of radio resources, whether or not the mobile station has a packet switched connection, etc.

In some wireless communications systems, for example, in Universal Mobile Telecommunications System (UMTS) 3G W-CDMA communications networks, if the mobile station (referred to as user equipment (UE) in UMTS 3G W-CDMA) does not select the correct cell, cell reselection is initiated immediately. Unnecessary cell selection is generally to be avoided.

The cell selection/reselection procedures generally require a finite amount of time. During cell selection upon transitioning to a common channel, for example, the wireless communications device cannot immediately receive pages on the common channel, which must first be configured for paging. Particularly, during cell selection, the mobile station must read the system information message of the available cells and, following cell selection, configure the paging channel of the cell selected prior to receiving any paging messages. Thus during the selection and configuration procedures, which may require several seconds or more, the mobile station is unable to receive any pages addressed to it since the mobile station has not yet been configured to receive messages on the paging channel. The selection and configuration processes are slowed by the period (repeat cycle) of the network system information broadcast message. In UMTS W-CDMA communications systems this information repeats over a period measured in frames.

The 3^{rd} Generation Partnership Project (3GPP) Radio Resource Control 25.331 specification states the procedure for moving to a common channel from a dedicated channel state including a requirement that the mobile station perform cell selection. However, the 3GPP Radio Resource Control 25.331 specification does not specify the manner or procedures in which the user equipment (UE) should perform cell selection.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 illustrates a wireless communications system including a wireless mobile station that communicates with one or more cells of the wireless communications infrastructure.

FIG. 2 is an exemplary common channel configuration process flow diagram.

FIG. 3 is an alternative common channel configuration process flow diagram.

### DETAILED DESCRIPTION

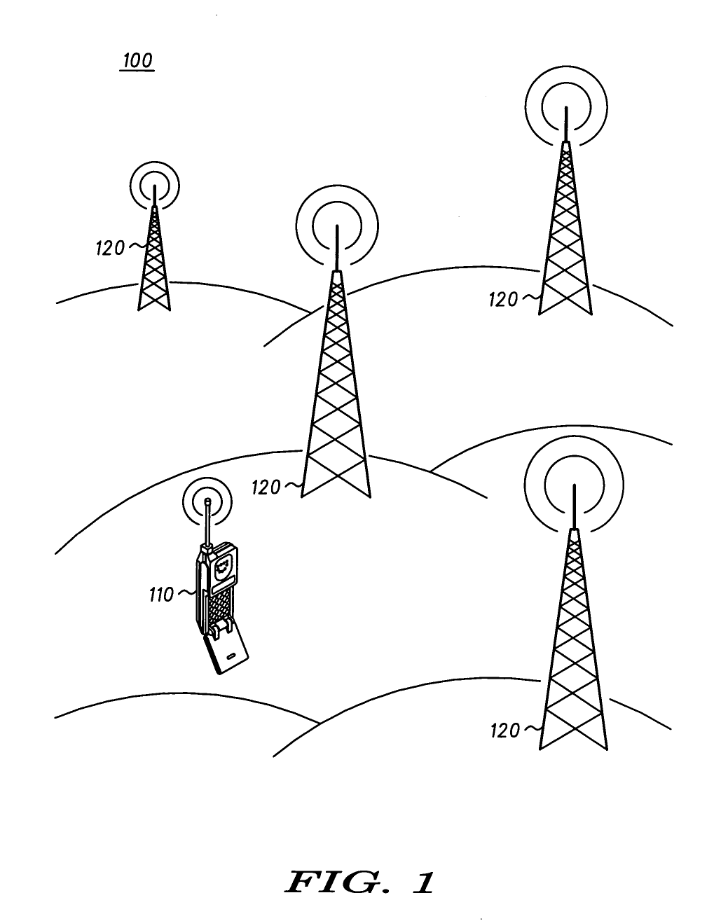

FIG. 1 is an exemplary wireless communications system 100 including a mobile wireless communications device 110, for example, a cellular subscriber device, that communicates with other wireless mobile devices and entities via a communications network infrastructure. The exemplary communications network infrastructure includes multiple cellular area transceivers 120 communicably coupled to communications infrastructure, well known but not illustrated, for providing uninterrupted wireless communications service in adjacent geographical areas, or cells, as the mobile device travels about. The communications infrastructure may also include gateways and switches for providing access to circuit switched and packet networks.

In some wireless communications systems, for example, in Universal Mobile Telecommunications System (UMTS) 3G W-CDMA protocol compliant the system, mobile wireless communications devices select and reselect cells from time to time with changes in operating mode and location within the network. In the instant disclosure, the terms selection and reselection are used synonymously. In UMTS 3G W-CDMA communications systems, the wireless communications device is referred to as user equipment (UE), and each of the cellular transceivers 120 in FIG. 1 is known as a node B. In other wireless communications systems, the wireless mobile station and transceiver equipment may be known by other names.

In UMTS W-CDMA systems, generally, mobile subscriber devices, for example, UE 110 in FIG. 1, receive pilot and synchronization channel information from on or more neighboring base station transceivers, or nodes B, 120. Each exemplary node B has a unique pilot signal distinguished from neighboring pilot signals by a scrambling code. The user equipment 110 must generally identify the neighboring base station pilot signals, which are used by the subscriber device to identify the presence of the network, for system acquisition, for demodulation of the synchronization, paging and traffic channels, and for handoffs. The user equipment monitors pilot signals, and the signals that satisfy one or more criteria, for example, a signal quality, bit error rate (BER), etc., become part of an active set of signals from which the user equipment 110 performs cell selection, as is known generally by those having ordinary skill in the art.

In some embodiments, it is desirable to select cells appropriately so that unnecessary cell reselection and unnecessary signaling is avoided, since these processes require the allocation of resources, including, for example, battery power, radio resources, etc. It is also desirable, in some embodiments, to quickly configure the common channel, for example, the paging channel, upon transition from dedicated mode to lessen the likelihood that the paging information is missed by the UE. In many applications, over time, expedited common channel configuration will also result in the accrual of not insubstantial power savings at the wireless communication device.

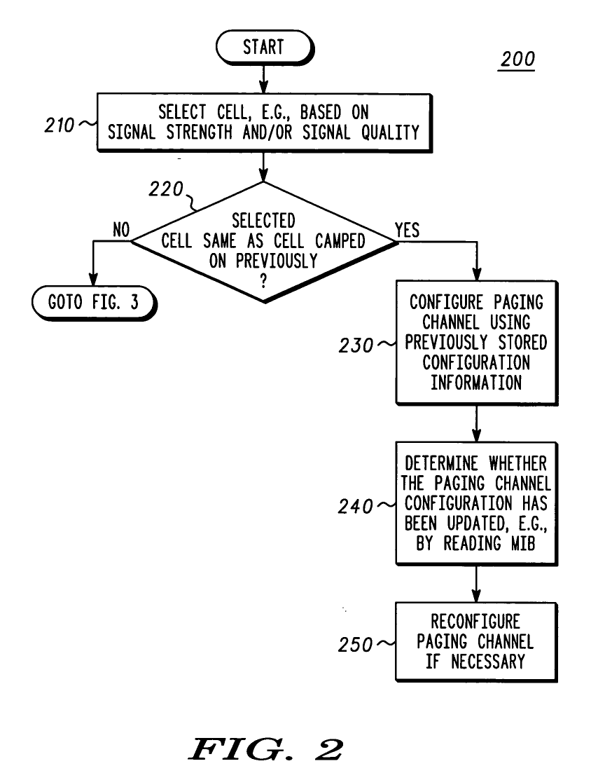

In the exemplary process 200 of FIG. 2, at block 210, a wireless communications device, selects a cell. In one exemplary embodiment, cell selection occurs upon transition from a Dedicated Channel (DCH) to a common channel, for example, to a Forward Access Channel (FACH) in the exemplary W-CDMA wireless communications system. The cell selection at block 210 may be based on any number of one or more criteria including, for example, signal strength and/or signal quality, e.g., in terms of bit error rate (BER), among others cell selection criteria, some of which is well known in the art.

At block 220, a determination is made as to whether the selected cell is the same as a cell camped on previously by the wireless communications device. In one embodiment, after transitioning from dedicated mode to common mode, for example, a determination is made as to whether the cell selected, at block 210 in FIG. 2, is the same as a cell last camped on by the wireless communications device when it was last in common mode operation, prior to transitioning to dedicated mode and back to common mode.

In FIG. 2, at block 230, if the selected cell is the same as the cell camped on previously, the wireless communications device is configured for the paging channel of the previously camped on cell using system information previously obtained previously. According to this aspect of the disclosure, the wireless communications device does not wait to obtain system information for the selected cell before configuring the paging channel. Instead, the wireless communications device is configured for the paging channel of the cell camped on previously using paging channel configuration information already stored previously on the device. Configuring for the paging channel of the cell last camped eliminates delay required for the wireless communications device to obtain the paging configuration information from the system information, which is usually broadcast over a periodic time interval. By configuring the paging channel immediately using paging channel configuration information for the cell camped on previously, without first obtaining system information for the selected cell, the wireless communication device can begin monitoring the paging channel relatively quickly, thereby reducing the likelihood that it will miss a page on the paging channel while configuring or updating the paging channel of the newly selected cell.

In FIG. 2, at block 240, the wireless communications device determines whether there is any updated system information for the paging channel. In UMTS W-CDMA wireless communications systems, any updates to the system information are indicated by the master information block (MIB) information, which is broadcast periodically. Thus the wireless communication device may determine whether the configuration of the paging channel has been updated by reading the MIB or similar information in other wireless communications systems. In some embodiments, the wireless device simultaneously reads the MIB while configuring for the paging channel of the cell camped on previously. In the exemplary W-CDMA application, the wireless communication device determines whether value tags read in the MIB have changed, and if so the wireless communications device obtains the updated paging channel configuration by reading the system information block (SIB). In FIG. 2, at block 250, the wireless communications device updates the paging channel configuration if necessary.

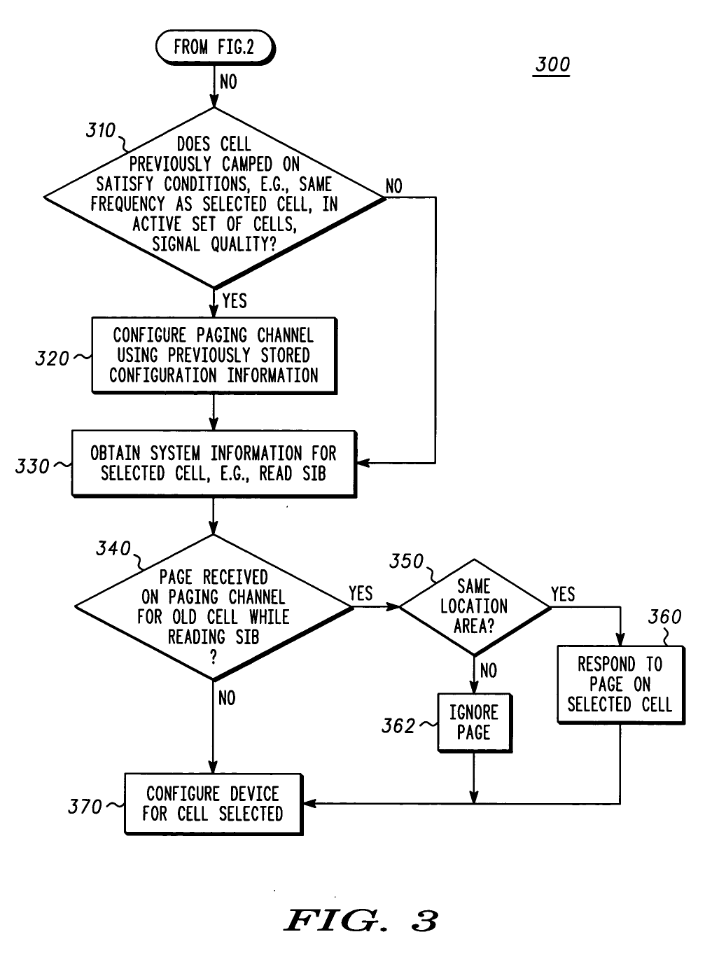

If the cell selected at block 210 in FIG. 2 is not the same as the cell camped on previously, as determined at block 220 in FIG. 2, then the process proceeds to the process 300 illustrated in FIG. 3. In FIG. 3, at block 310, a determination is made as to whether the cell camped on previously satisfies certain conditions. Exemplary conditions include, for example, whether the cell previously camped on is on the same frequency as the cell selected, whether the cell previously camped on is in the active set of cells, and whether the cell previously camped on satisfies a signal level threshold requirement.

In FIG. 3, at block 320, if the one or more conditions are satisfied at block 310, the wireless communications device is configured for a paging channel of the previously camped on cell using system information previously obtained for the cell previously camped on, as discussed above in connection with block 230 in FIG. 2. The wireless communications device preferably configures the paging channel using paging channel configuration information previously stored on the device, for example, that required for the paging channel of last camped on cell. Using the previously stored paging configuration information for the previously camped on cell eliminates the delay required for the wireless communications device to obtain system configuration information for the newly selected cell, for example, the cell selected at block 210 in FIG. 2.

In FIG. 3, at block 330, the wireless communications device obtains paging configuration information for the cell selected, for example, the cell selected at block 210 in FIG. 2. In the exemplary W-CDMA application, the paging configuration information is obtained by reading the system information block (SIB) of the selected cell. In some embodiments, if the one or more conditions are satisfied at block 310, the wireless communications device obtains the paging configuration information for the newly selected cell at the same time it configures for the paging channel of the cell camped on previously. In FIG. 3, at block 350, if a page is received by the wireless communications device while it is configured for the paging channel of the cell camped on previously, for example, while obtaining paging configuration information for the newly selected cell, the wireless communications device determines whether the location area (LA) of the selected cell is the same as the location area of the cell camped on previously for which the paging channel is presently configured. At block 360, if the location areas are the same, the wireless communications device may respond to the page on the selected cell. At block 362, if the location areas are not the same, the wireless communications device may ignore the page.

In FIG. 3, at block 370, the wireless communications device is configured for the paging channel of the cell selected using system information, for example, system information block (SIB) information, obtained for the cell selected while the paging channel was configured for the cell camped on previously.

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

1. A method in a wireless communications device that performs cell selection, the method comprising:
selecting a cell;
after selection, configuring the wireless communications device for a paging channel of a cell previously camped on by the wireless communications device using system information previously obtained for the cell previously camped on.

2. The method of claim 1,
determining whether the selected cell is a cell last camped on by the wireless communications device,
configuring the wireless communications device for a paging channel of the cell last camped on using system information previously obtained for the cell last camped on if the selected cell is the same as the cell last camped on.

3. The method of claim 2,
selecting the cell includes selecting a strongest cell among a one or more active cells.

4. The method of claim 1,
obtaining system information for the selected cell after configuring the paging channel if the selected cell is the cell camped on previously by the wireless communications device,
configuring the paging channel based on the updated system information.

5. The method of claim 1,
determining whether there is any updated system information for the selected cell after configuring the paging channel for the cell camped on previously,
reconfiguring the paging channel based upon any updated system information.

6. The method of claim 5,
determining whether there is any updated system information based on master information block information for the selected cell.

7. The method of claim 6, obtaining updated system information from a system information block for the selected cell based on the master information block information.

8. A method in a wireless communications device that performs cell selection, the method comprising:
selecting a cell;
after selection, configuring the wireless communications device for a paging channel of a cell camped on previously,
the selected cell different than the cell previously camped on.

9. The method of claim 8,
selecting the cell includes selecting a strongest cell among a plurality of active cells.

10. The method of claim 8,
configuring the wireless communications device for the paging channel for a cell last camped on using system information previously obtained for the cell last camped on,
the selected cell different than the cell last camped on.

11. The method of claim 9,
obtaining system information for the selected cell while the wireless communications device is configured for the paging channel of the cell previously camped on.

12. The method of claim 11,
reconfiguring the wireless communications device for the paging channel of the selected cell using system information obtained for the cell selected.

13. The method of claim 9,
receiving a page while the wireless communications device is configured for the paging channel of the cell previously camped on.

14. The method of claim 13,
responding to the received page on the selected cell if the selected cell and the previously camped on cell are in the same location area.

15. The method of claim 8,
conditionally configuring the wireless communications device for the paging channel of the cell camped on previously.

16. The method of claim 15, conditionally configuring the wireless communications device for the paging channel of the cell camp on previously based on least one of
a condition that the selected cell and the cell camped on previously are on the same frequency,
a condition that the cell camped on previously is in at least one of an active or monitored set of cells,
a condition that a signal strength of the cell camped on previously satisfies a threshold condition.

17. A method in a wireless communications device that performs cell selection, the method comprising:
selecting a cell;
after selection, configuring the wireless communications device for a paging channel of a cell camped on previously using system information obtained for the cell camped on previously whether or not the selected cell is the same as the cell camped on previously.

18. The method of claim 17, configuring the wireless communications device for the paging channel of the cell camped on previously using system information previously obtained for a cell last camped on.

19. The method of claim 17,
obtaining updated system information for the selected cell if the selected cell is the same as the cell camped on previously,
configuring the paging channel based upon any updated system information obtained for the selected cell.

20. The method of claim 17,
obtaining system information for the selected cell while the wireless communications device is configured for the paging channel of the cell camped on previously.

21. The method of claim 17,
reconfiguring the wireless communications device for the paging channel of the selected cell after obtaining system information for the selected cell.
